(19) United States
(12) Patent Application Publication
(10) Pub. No.: US 2022/0156468 A1
(43) Pub. Date: May 19, 2022

(54) METHOD AND APPARATUS FOR GENERATING KNOWLEDGE GRAPH

(71) Applicant: TmaxAI Co., Ltd., Seongnam-si (KR)

(72) Inventors: Kichang KIM, Seongnam-si (KR); Jonghyun SEONG, Seoul (KR); Wonyl CHOI, Seoul (KR); Jeong Hyun CHOI, Seongnam-si (KR); Youngrok JANG, Yongin-si (KR)

(21) Appl. No.: 17/470,084

(22) Filed: Sep. 9, 2021

(30) Foreign Application Priority Data
Nov. 19, 2020 (KR) 10-2020-0155264

(51) Int. Cl. G06F 40/47; G06N 5/02

(52) U.S. Cl. CPC G06F 40/47; G06N 5/025

(57) ABSTRACT

According to an exemplary embodiment of the present disclosure, there is disclosed a method of analyzing text data performed by a computing device including at least one processor. The method may include: obtaining a concept word list including two or more concept words and a knowledge text for each concept word from an input document; calculating relationship information between two concept words included in the concept word list; and generating knowledge graph data based on the concept word list, the knowledge text for each of the concept words, and the relationship information.

### CROSS-REFERENCE TO RELATED APPLICATIONS

This application claims priority to and the benefit of Korean Patent Application No. 10-2020-0155264 filed in the Korean Intellectual Property Office on Nov. 19, 2020, the entire contents of which are incorporated herein by reference.

### TECHNICAL FIELD

The present disclosure relates to a method of building a knowledge graph, and more particularly, to a method of generating knowledge graph data by modelling knowledge for a specific field.

### BACKGROUND ART

The existing knowledge graph-related technology in the art declares entities and defines a relationship between the entities by using a graph structure. Based on the data structure, the question and answer problem and recommendation problem have been solved.

However, in the knowledge graph technology, in addition to the common point of using a data structure called a graph, there is a problem of how to set the relationship between the nodes in order to solve technical problems in each technology field. In particular, the general knowledge graph-related technology is based on user preference, so the general knowledge graph-related technology is not appropriate to be used as a knowledge graph generating technology in customized learning, such as analyzing a learning level of a student and providing appropriate contents in an education field.

Accordingly, in the industry, there has been a continuous demand for the development of a knowledge graph suitable for the field of education.

Korean Patent No. KR1686068 discloses a question and answer method and system using concept graph matching.

### SUMMARY OF THE INVENTION

The present disclosure is conceived in response to the background art, and has been made in an effort to provide a method of generating a knowledge graph data by modelling knowledge for a specific field.

According to an exemplary embodiment of the present disclosure for implementing the foregoing object, there is disclosed a method of analyzing text data performed by a computing device including at least one processor. The method may include: obtaining a concept word list including two or more concept words and a knowledge text for each concept word from an input document; calculating relationship information between two concept words included in the concept word list; and generating knowledge graph data based on the concept word list, the knowledge text for each of the concept words, and the relationship information.

In an alternative exemplary embodiment, the obtaining of the concept word list including the two or more concept words and the knowledge text for each concept word from the input document may include: obtaining learning unit information for at least one text included in the input document; and obtaining a concept word list including two or more concept words and a knowledge text for each concept word based on the learning unit information.

In the alternative exemplary embodiment, the learning unit information may include two or more learning unit elements having a parent-child relationship.

In the alternative exemplary embodiment, the relationship information between the two concept words included in the concept word list may include an association relationship representing whether the concept words are associated or the degree of association, and the association relationship may be calculated based on a distance between the two concept words or a co-appearance frequency of the two concept words in the input document.

In the alternative exemplary embodiment, the relationship information between the two concept words included in the concept word list may include an inclusion relationship representing a superordinate-subordinate relationship between the concept words, and the inclusion relationship may be determined based on a morpheme analysis result of a knowledge text for at least one of a first concept word and a second concept word which have an association relationship.

In the alternative exemplary embodiment, the relationship information between the two concept words included in the concept word list may include a precedence relationship representing a precedence relationship between the concept words, and the precedence relationship may be determined based on a morpheme analysis result of a knowledge text for at least one of a first concept word and a second concept word which have an association relationship.

In the alternative exemplary embodiment, the precedence relationship may be determined based on a comparison result of learning unit information for each of the first concept word and the second concept word which have the association relationship.

In the alternative exemplary embodiment, the generating of the knowledge graph data based on the concept word list, the knowledge text for each of the concept words, and the relationship information may include: generating a logical formula based on the knowledge text or the relationship information for the concept word; generating an ontology language based on the generated logical formula; and generating knowledge graph data based on the generated ontology language.

In the alternative exemplary embodiment, the knowledge graph data may include a concept word node or a concept word relationship edge, and the concept word node may be generated based on a concept word expression included in the ontology language, and the concept word relationship edge may be generated based on a relationship expression included in the ontology language.

In the alternative exemplary embodiment, the knowledge graph data may include: two or more concept word nodes expressing the concept words; and at least one concept word relationship edge expressing the relationship between the concept words.

In the alternative exemplary embodiment, the knowledge graph data may further include: at least one learning unit node expressing a learning unit; and at least one concept word-learning unit edge expressing a relationship between the concept word and the learning unit.

According to another exemplary embodiment of the present disclosure for implementing the foregoing object, there is disclosed a computer program stored in a computer readable storage medium. When the computer program is executed by one or more processors, the computer program performs following operations for generating knowledge graph data, the operations including: obtaining a concept word list including two or more concept words and a knowledge text for each concept word from an input document; calculating relationship information between two concept words included in the concept word list; and generating knowledge graph data based on the concept word list, the knowledge text for each of the concept words, and the relationship information.

According to another exemplary embodiment of the present disclosure for implementing the foregoing object, there is disclosed an apparatus for generating knowledge graph data. The apparatus may include: one or more processors; a memory; and a network unit, in which the one or more processors may obtain a concept word list including two or more concept words and a knowledge text for each concept word from an input document, calculate relationship information between two concept words included in the concept word list, and generate knowledge graph data based on the concept word list, the knowledge text for each of the concept words, and the relationship information.

The present disclosure may provide the method of generating knowledge graph data by modelling knowledge for a specific field.

### BRIEF DESCRIPTION OF THE DRAWINGS

FIG. 1 is a block diagram of a computing device for generating knowledge graph data according to an exemplary embodiment of the present disclosure.

FIG. 2 is a diagram illustrating an example in which data included in a learning unit information is expressed in a tree.

FIG. 3 a diagram illustrating an example of knowledge graph data generated according to the exemplary embodiment of the present disclosure.

FIG. 4 a diagram illustrating an example of knowledge graph data including a concept word node expressing a concept word and a learning unit node expressing a learning unit according to the exemplary embodiment of the present disclosure.

FIG. 5 is a flowchart illustrating a method of generating knowledge graph data according to an exemplary embodiment of the present disclosure.

FIG. 6 is a simple and general schematic diagram illustrating an example of a computing environment in which the exemplary embodiments of the present disclosure are implementable.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

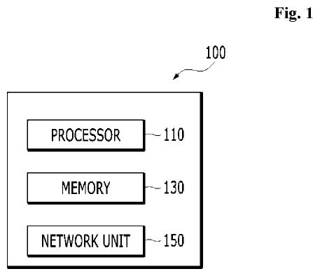

FIG. 1 is a block diagram of a computing device for generating knowledge graph data according to an exemplary embodiment of the present disclosure.

The configuration of a computing device 100 illustrated in FIG. 1 is merely a simplified example. In the exemplary embodiment of the present disclosure, the computing device 100 may include other configurations for performing a computing environment of the computing device 100, and only some of the disclosed configurations may also configure the computing device 100.

The computing device 100 may include a processor 110, a memory 130, and a network unit 150.

The processor 110 may be formed of one or more cores, and may include a processor, such as a central processing unit (CPU), a general purpose graphics processing unit (GPGPU), and a tensor processing unit (TPU) of the computing device, for performing a data analysis and deep learning. The processor 110 may read a computer program stored in the memory 130 and perform data processing for generating knowledge graph data according to the exemplary embodiment of the present disclosure. The processor 110 may obtain a concept word list including two or more concept words from an input document and a knowledge text for each concept word. The processor 110 may calculate relationship information between two concept words included in the concept word list. The processor 110 may generate knowledge graph data based on the concept word list, the knowledge text for each concept word included in the concept word list, and the relationship information between the two concept words.

According to the exemplary embodiment of the present disclosure, the memory 130 may store a predetermined type of information generated or determined by the processor 110 and a predetermined type of information received by a network unit 150.

According to the exemplary embodiment of the present disclosure, the memory 130 may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The computing device 100 may also be operated in relation to web storage performing a storage function of the memory 130 on the Internet. The description of the foregoing memory is merely illustrative, and the present disclosure is not limited thereto.

The network unit 150 according to the exemplary embodiment of the present disclosure may include predetermined wire/wireless communication networks capable of transceiving any type of data and signal expressed in the contents of the present disclosure.

The network unit 150 in the present disclosure may be configured regardless of its communication mode, such as a wired mode and a wireless mode, and may be configured of various communication networks, such as a Personal Area Network (PAN) and a Wide Area Network (WAN). Further, the network may be the publicly known World Wide Web (WWW), and may also use a wireless transmission technology used in PAN, such as Infrared Data Association (IrDA) or Bluetooth.

The technologies described in the present specification may be used in other networks, as well as the foregoing networks.

The configuration of a computing device 100 illustrated in FIG. 1 is merely a simplified example. In the exemplary embodiment of the present disclosure, the computing device 100 may include other configurations for performing a computing environment of the computing device 100, and only some of the disclosed configurations may also configure the computing device 100.

The computing device 100 according to the present disclosure may obtain a concept word list including two or more concept words in an input document and knowledge text for each concept word. The computing device 100 according to the present disclosure may be at least partially based on a morpheme analysis operation for extracting a concept word and knowledge text for the concept word from the input document including text data. In the content of the present disclosure, the “knowledge text for the concept word” may be used interchangeably with the “text including a content that explains, limits, and specifies the concept word, as the content related to the concept word”.

The computing device 100 according to the present disclosure may divide the input text into a morpheme unit and analyze the input text through the morpheme analysis operation. For example, the computing device 100 may analyze the input text by dividing the input text into a full morpheme and a formal morpheme. For another example, the computing device 100 may analyze the input text by dividing the input text into a lexical morpheme and a grammatical morpheme. In particular, when the computing device 100 performs the morpheme analysis operation on the text “ [symbol] [symbol] ”, the computing device 100 may obtain a morpheme analysis result “ [symbol] noun+ [symbol] case marker+ [symbol] verb+ [symbol] pre-final ending+ [symbol] /final ending”. For another example, when the computing device 100 performs the morpheme analysis operation on the text “ [symbol] [symbol] [symbol] [symbol] ”, the computing device 100 may obtain a morpheme analysis result “ [symbol] /common noun+ [symbol] postpositional particle+ [symbol] /common noun+ [symbol] /adnominal case marker+ [symbol] /common noun+ [symbol] /adverbial case marker+ [symbol] /verb+ [symbol] /connective ending+ [symbol] /common noun+ [symbol] /subject case marker+ [symbol] /verb+ [symbol] /connective ending+ [symbol] /common noun+ [symbol] /subject case marker+ [symbol] /verb+ [symbol] /adnominal ending+ [symbol] /common noun+ [symbol] /affirmative indication+ [symbol] /connective ending”. The particular performance process of the morpheme analysis is the publicly known knowledge, so that the detailed description thereof will be omitted.

The computing device 100 according to the present disclosure may extract text tokens corresponding to nouns and noun phrases for extracting a concept word after the performance of the morpheme analysis. The computing device 100 may select at least a part of the text tokens corresponding to the noun and the noun phrase as concept words. For example, when the morpheme analysis is performed on the text “An equation is a formula that becomes true or false depending on the value of the unknown.” and the text tokens corresponding to the noun and the noun phrase are extracted, the computing device 100 may extract “equation, unknown, value, true, false, and formula” as the text tokens corresponding to the nouns and the noun phrases. Then, the computing device 100 may select “equation and unknown” among the extracted text tokens as the concept words. Finally, the computing device 100 may obtain a concept word list including two or more concept words from the input document. The concept word extracting method is merely the example for description, and the concept word extracting operation of the present disclosure is irrelevant to the content of the text included in the input document and includes various exemplary embodiments of extracting a concept word based on a morpheme analysis result.

The computing device 100 may include a predefined concept word dictionary. The predefined concept word dictionary may serve as a basis for extracting a concept word from text tokens corresponding to noun and noun phrases. Further, the concept word may also be selected based on the user's intervention through a UI. As described above, the computing device 100 of the present disclosure may provide the method for a user to extract concept words in a knowledge field desired by the user from an input document.

The computing device 100 according to the present disclosure may obtain a knowledge text for each concept word included in the concept word list from the input document. In the present disclosure, the operation of obtaining, by the computing device 100, the knowledge text for each concept word may be performed before, after, or simultaneously with the foregoing concept word extracting operation in parallel, and the execution time is not limited.

The computing device 100 in the exemplary embodiment according to the present disclosure may obtain a text of a predetermined length including each concept word in the input document as a knowledge text for the concept word. The predetermined length may be N words before and after the concept word. For example, the computing device 100 may obtain a knowledge text for the concept word “equation” in the sentence “the equation shown above contains only numbers, but most often there are variables as well. It is called an equation and the goal is to find the value of a variable that makes it true”. In this case, when seven words before and after the concept word are set as the knowledge texts for the concept word, the computing device 100 may obtain the sentence “most often there are variables as well. It is called an equation and the goal is to find the value of a variable that makes it true” as the knowledge text for the “equation” in the foregoing example.

In the exemplary embodiment according to the present disclosure, the computing device 100 may obtain a sentence-unit text including each concept word in the input document as a knowledge text for the concept word. For example, in the sentence “the equation shown above contains only numbers, but most often there are variables as well. It is called an equation and the goal is to find the value of a variable that makes it true.”, the computing device 100 may obtain “It is called an equation and the goal is to find the value of a variable that makes it true.” as the knowledge text for the concept “equation”.

As described above, the computing device 100 of the present disclosure may obtain the concept word list including two or more concept words from the input document, and in this case, the computing device 100 may also obtain the knowledge text for explaining each concept word from the input document.

In some exemplary embodiments of the present disclosure, the operation of obtaining, by the computing device, the concept word list including two or more concept words and the knowledge text related to each concept word from the input document may include an operation of obtaining learning-unit information for at least one text included in the input document, and an operation of obtaining the concept word list including two or more concept words and a knowledge text related to each concept word based on the learning unit information.

In the present disclosure content, the learning unit information may include information representing a location of at least a part of the texts included in the input document in the predetermined learning process. The at least the part of the text may include a morpheme unit, a syllable unit, a word unit, a sentence unit, or a paragraph unit. The learning unit information may include at least one of, for example, grade information, semester information, large lesson unit information, middle lesson unit information, small lesson unit information, and paragraph information. In the exemplary embodiment of the present disclosure, for the sentence “the Pythagorean theorem states that the square of the length of the hypotenuse in a right-angled triangle is equal to the sum of the square of the length of each of the two right-angled sides”, the computing device 100 may obtain the learning unit information including the content “middle school, second year, second semester, unit 3, Pythagorean theorem, and definition of Pythagorean theorem”. In another exemplary embodiment of the present disclosure, the computing device 100 may also obtain the learning unit information including the content “middle school, second year, second semester, unit 3, Pythagorean theorem, and definition of Pythagorean theorem” for the word “Pythagorean”.

The computing device 100 according to the present disclosure may receive text data and the learning unit information from the user and obtain the learning unit information for at least one text included in the input document. Further, the computing device 100 may obtain the learning unit information for at least one text included in the input document by parsing the text included in the input document. The text parsing includes an operation of sequentially receiving the text based on a token or character string unit and recognizing a meaning of the text. The text parting may also include an operation of recognizing a physical form of the text included in the input document.

In the exemplary embodiment of the present disclosure, the computing device 100 may obtain content table information from the input document, and obtain the learning unit information for at least one text included in the input document based on the obtained content table information. For example, educational materials may contain information about an order or a table of contents for the entire content. Accordingly, the computing device 100 may obtain the content table information, generate the learning unit information including the large lesson unit, the middle lesson unit, or the small lesson unit based on the obtained content table information, and then associate the generated learning unit information with the text. The computing device 100 may also generate the learning unit information for the text based on the page information included in the content table information.

In another exemplary embodiment of the present disclosure, the computing device 100 may also obtain the learning unit information based on the physical form of the text included in the input document. The physical form of the text may include at least one of the size of the text, the thickness of the text, the starting position of the text in the document, and the shape of the number signs included in the text. In particular, when a first text and a second text are sequentially present in the input document and a size of a character string of the first text is larger than a size of a character string of the second text, the computing device 100 may set the first text as a learning unit element name for the second text. Further, the computing device 100 may obtain the learning unit information based on the shape of the number sign included in the text from the input document. For example, the input document may be the document written using different number signs, such as “I, 1, 1), (1)”, for discriminating the contents. In this case, the difference in the number sign means a different in the learning unit, so that the computing device 100 may obtain the learning unit information for at least a part of the text included in the input document based on the number sign.

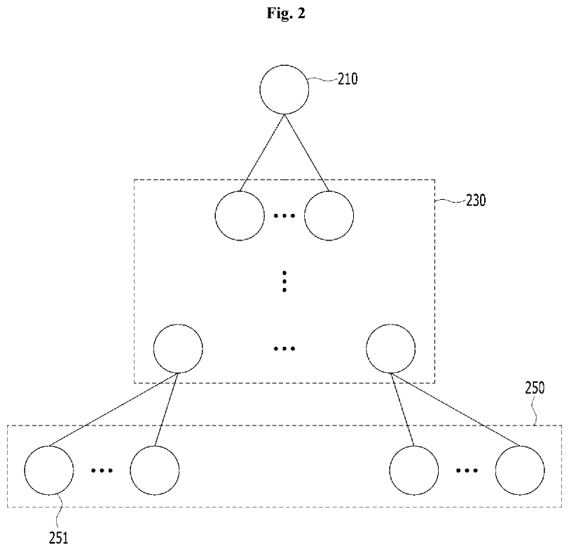

FIG. 2 is a diagram illustrating an example in which data included in learning unit information is expressed in a tree. As illustrated in FIG. 2, the learning unit information may include two or more learning unit elements having a parent-child relationship. Each learning unit element included in the learning unit information may be expressed by a node in a tree. The parent-child relationship present between at least some of the elements among the learning unit elements may be expressed by an edge in the tree. Reference numeral 210 represents a maximum learning unit element among the plurality of learning unit elements included in the learning unit information. The maximum learning unit element 210 may include a name associated with the widest range of learning unit for the content included in the input document. The maximum learning unit element 210 may include a name associated with, for example, “full curriculum”, “grade”, or “semester”. Reference numeral 230 of FIG. 2 represents middle learning units among the plurality of learning unit elements included in the learning unit information. The middle learning unit element set 230 includes the learning units presented between the maximum learning unit and the minimum learning unit. One or more middle learning units included in the middle learning unit element set 230 may include a name associated with “semester”, “large lesson unit”, “middle lesson unit”, or “small lesson unit”. Reference numeral 250 of FIG. 2 represents a set of minimum learning units among the plurality of learning units included in the learning unit information. The minimum learning unit set 250 may include the smallest learning units for explaining the learning unit. The minimum learning unit set 250 may be the set of leaf nodes existing in the tree when the learning unit information is expressed in the form of the tree. In the exemplary embodiment, the first minimum learning unit 251 included in the minimum learning unit set 250 may include a title of the small lesson unit of a textbook. In another exemplary embodiment, the first minimum learning unit 251 may also include a name of paragraph information to be learned in a unit class time. The unit class time may include, for example, one class, one hour, one day, or one week. FIG. 2 only illustrates that the learning unit information may be visually represented as a tree, and it will be apparent that the learning unit information described in the present disclosure may be obtained and/or stored even without a visual representation of the tree structure. As described above, the computing device 100 according to the present disclosure may obtain the learning unit information for each of the plurality of texts included in the input document. The learning unit information is the information including the location information in the educational process for the content of the text, so that the computing device 100 according to the present disclosure may classify the plurality of texts included in the input document according to the order of the educational process.

The computing device 100 according to the present disclosure may obtain a concept word list including two or more concept words and a knowledge text related to each concept word based on the learning unit information. According to the present disclosure, the method of obtaining the concept word list including two or more concept words from the input document has been described in detail, so that the overlapping contents will be omitted and the difference will be mainly described hereinafter.

When the computing device 100 obtains the concept word list including two or more concept words, the computing device 100 may additionally include the learning unit information for each concept word. In particular, the concept word list for the input document may be generated by the computing device 100 like “equation, Pythagoras”. In this case, when the computing device 100 additionally considers the learning unit information, the concept word list may also be generated like “Equation_2nd grade, 1st semester, 5th lesson unit, Pythagoras_2nd grade, 2nd semester, 3rd lesson unit”. The computing device 100 may group the concept words for each learning unit element included in the learning unit information by including the concept words and the learning unit information matched with the concept word in the concept word list. In the continuous example, in the case where the concept word list including the content “Equation_2nd grade, 1st semester, 5th lesson unit, Pythagoras_2nd grade, 2nd semester, 3rd lesson unit” is generated as described, when the computing device 100 groups the concept words according to each semester, the “equation” is the concept word of the first semester and the “Pythagoras” is the concept word of the second semester, so that the concept words may be separated from each other and classified. When the computing device 100 groups the concept words for each grade, the “equation” and the “Pythagoras” are the concept words of the second grade, so that both the “equation” and the “Pythagoras” may be grouped into the same group. As described above, when the concept word list is obtained based on the learning unit information according to the present disclosure, there is an advantage in that it is possible to classify the plurality of concept words obtained from the input document according to the learning range. That is, the computing device 100 may classify the concept words included in a specific learning range, and identify which concept words need to be additionally learned in the process of expanding the learning unit.

In the exemplary embodiment according to the present disclosure, the computing device 100 may calculate relationship information between two concept words included in the concept word list. The relationship information may include an association relationship that indicates whether the concept words are associated with each other or the degree of association between the concept words. In the content of the present disclosure, “the two concept words have the association relationship” may be used to mean “a value representing the degree of association calculated based on the two concept words is larger than a predetermined threshold value”. The association relationship may be calculated based on a distance between two concept words or a co-appearance frequency of two concept words in the input document.

The computing device 100 according to the present disclosure may determine an association relationship based on a distance between two concept words. The distance between the two concept words may be calculated based on the number of words existing between the two concept words in a sentence. For example, when it is assumed that there are concept words A and B, in a first example sentence “A is B”, since there is 0 word between the word “A is” and the word “B”, so that the computing device 100 may calculate the distance between the two concept words as 0. In the continuous exemplary embodiment, in a second example sentence “A is B whose divisors are 1 and itself only”, the computing device 100 may calculate the distance between the two concept words as 5. When a calculated average distance between the two concept words is equal to or smaller than a threshold value, the computing device 100 may determine that the two concept words have the association relationship. For example, when a threshold value for the average distance between the two concept words is 3, and there are N sentences in which A and B appear at the same time, and an average value for the distance between the two concept words in the N sentences is 2.5, the computing device 100 of the present disclosure may determine that A and B have the association relationship.

The computing device 100 according to the present disclosure may determine an association relationship based on the co-appearance frequency of the two concept words. For example, when k concept words are included in the concept word list, the computing device 100 may calculate the number of times of the co-appearance in the input document for each of the combinations of the concept word pairs including two or more predetermined concept words among the K concept words. The reference of the co-appearance determination may be based on a sentence, a paragraph, a document page, or a predetermined unit length. In the particular exemplary embodiment, when there are 10 sentences including both concept word A and concept word B among the sentences included in the input document, the computing device 100 may calculate the co-appearance frequency of concept word A and concept word B as 10. When the number of times of the co-appearance of the two concept words is equal to or larger than a predetermined threshold, the computing device 100 may determine that two concept words have the association relationship.

The computing device 100 according to the present disclosure may also calculate the association relationship based on both the distance between the two concept words and the co-appearance frequency of the two concept words. For example, the computing device 100 may determine that the two concept words have the association relationship only when the number of sentences in which the concept words A and B simultaneously appear is equal to or larger than the predetermined number, and at the same time, the distance between A and B is equal to or less than a threshold distance. The foregoing method may have an effect of removing noise, such as the case where the co-appearance frequency itself of the two concept words is little even though the average distance between the two concept words is equal to or less than the threshold value, or the case where the distance between the two concept words is excessively large, so that it is determined that the two concept words do not have the relationship even though the two concept words appear frequently and simultaneously.

The description of the association relationship calculating method is only an example for the implementation, and the present disclosure includes various methods of calculating the association relationship based on the distance between two concept words or the co-appearance frequency of the two concept words in the input document without limitation.

The relationship information according to the present disclosure may include an inclusion relationship indicating a superordinate-subordinate relationship between the concept words. The inclusion relationship may be determined by the computing device 100 based on a morpheme analysis result of a knowledge text for at least one concept word between a first concept word and a second concept word which have the association relationship. The computing device 100 may search for a syntax structure representing the inclusion relationship based on the morpheme analysis result in order to determine the inclusion relationship. The syntax structure representing the inclusion relationship may include, for example, an enumeration structure of subordinate concepts for a superordinate concept. For example, the enumeration structure of subordinate concepts for a superordinate concept may include sentence structures, such as “˜is included in˜.”, “an example of ˜includes˜.”, or “˜includes˜ and the like.”. In particular, when the sentence “a trigonometric function includes a sine function, a cosine function, a tangent function, and the like” is input to the computing device 100, the computing device 100 may identify a syntax structure indicating the inclusion relationship “A includes a1, a2, a3, and the like” based on at least a part of the morpheme analysis result, and then determine that the concept words a1, a2, and a3 are included in the concept word A. As a result, the computing device 100 may determine that the concept words “sine function”, “cosine function”, and “tangent function” have the inclusion relationship with the concept word “trigonometric function”. The example of the syntax structure indicating the inclusion relationship is for description only, and the present disclosure may include the syntax structure indicating the inclusion relationship that may be searched based on the morpheme analysis result without limitation. When the computing device 100 determines the inclusion relationship, the computing device 100 primarily targets the first concept word and the second concept words that are related with each other, so that the computing device 100 may select concept word pairs having a certain relevance who values indicative of relevance exceed a threshold value, before searching for the syntax structure representing the inclusion relationship. This has an effect of increasing a calculation speed.

The relationship information according to the present disclosure may include a precedence relationship indicating the order relationship between concept words. The precedence relationship may be determined based on the morpheme analysis result of the knowledge text for at least one concept word between the first concept word and the second concept word having the association relationship. For example, when concept word B appears in a knowledge text explaining concept word A, in order to understand concept word A, it is necessary to know concept word B, so that the precedence relationship with the meaning that concept word B precedes concept word A may be determined. The computing device 100 may search for the syntax structure representing the precedence relationship based on the morpheme analysis result in order to determine the precedence relationship. The syntax structure representing the precedence relationship may include the sentence structure, for example, “˜is˜.” and “˜refers to˜.”, or “˜means˜.”. In the particular example, when a sentence “a geometric sequence is a sequence of numbers formed by multiplying a constant number in order from the first term” is input to the computing device 100, the computing device 100 may identify that the concept word “sequence of numbers” needs to be preceded in order to explain the concept word “geometric sequence” based on at least a part of the morpheme analysis result. As a result, the computing device 100 may determine that the concept word pair of “geometric sequence” and “sequence of numbers” has the precedence relationship. The syntax structure representing the precedence relationship is merely the example for description, and the present disclosure may include the syntax structure representing the precedence relationship that may be searched based on the morpheme analysis result without limitation. The computing device 100 primarily targets the first concept word and the second concept word having the association relationship, similar to the inclusion relationship, when determining the precedence relationship, so that the computing device 100 determines the precedence relationship for the concept word pairs having the certain relevance whose values indicative of relevance exceed the threshold value, thereby achieving an effect of improving calculation performance.

The computing device 100 according to the present disclosure may determine the precedence relationship between two concept words based on a comparison result of learning unit information for each of the first concept word and the second concept word having the association relationship. As an example for description, it is assumed that the first concept word is “exponential equation” and the second concept word is “equation”. In this case, the knowledge text related to the first concept word may exist as “an exponential equation is an equation that includes an unknown in an exponent”. As described above, when the computing device 100 determines the precedence relationship based on the morpheme analysis result, the computing device 100 may determine that the concept word “exponential equation” and the concept word “equation” have the precedence relationship from the sentence. The computing device 100 may also determine the precedence relationship by using the learning unit information matched with each concept word regardless of the knowledge text for each concept word. That is, when “exponential equation” and “equation” have the association relationship, the learning unit information for “exponential equation” is “high school 2nd grade, 1st semester, 3rd lesson unit”, and the learning unit information for “equation” is “middle school 2nd grade, 1st semester, 5th lesson unit”, the computing device 100 may identify “equation” as the concept word that needs to precede “exponential equation” by comparing the learning unit information of “exponential equation” and “equation”. As a result, the computing device 100 may determine that “exponential equation” and “equation” have the precedence relationship. The foregoing example is merely the example for description, and the present disclosure may include various exemplary embodiments in which the precedence relationship between two concept words is determined based on eth comparison result of the learning unit information without limitation. As described above, the computing device 100 determines the precedence relationship by comparing the learning unit information of two concept words having the association relationship, so that it is possible to determine a precedence relationship even in an ambiguous sentence in which the precedence relationship cannot be searched based on the morpheme analysis. For example, there may be a sentence representing the precedence relationship that does not match any one of the syntax structures representing the precedence relationship among the sentences included in the input document. In this case, when the precedence relationship is determined by comparing the learning unit information for two concept words having the association relationship according to the present disclosure, there is an effect in that it is possible to more efficiently determine the concept word pair having the precedence relationship.

The operation of generating, by the computing device 100 according to the present disclosure, the knowledge graph text based on the concept word list, the knowledge text for each concept word, and the relationship information may include: generating a logical formula based on the knowledge text for the concept word or the relationship information; generating an ontology language based on the generated logical formula; and generating knowledge graph data based on the generated ontology language.

The computing device 100 according to the present disclosure may generate a logical formula based on the knowledge text for the concept word or the relationship information between the concept words. The computing device 100 may generate the logical formula based on the knowledge text consisting of propositions or predicates or the relationship information between two concept words based on Table 1 below.

TABLE 1

| Logical | | Logical | |
|---|---|---|---|
| symbol | Name | formula | Meaning |
| ¬ | Not | ¬P | Not P |
| ∨ | Logical sum | P ∨ Q | P or Q |
| ∧ | Logical product | P ∧ Q | P and Q |
| → | Consensus | P → Q | If P then Q |
| ≡ | Equivalent | P ≡ Q | P if and only if Q |

The computing device 100 according to the present disclosure may normalize the knowledge text and generate the logical formula at least partially based on Table 1. The logical formula may include a Conjunctive normal Form (CNF) or Disjunctive Normal Form (DNF).

In the exemplary embodiment, when there are two concept words A and B and there is the precedence relationship between A and B, in which A takes precedence over B, the computing device 100 may generate the logical formula “A→B”. In another exemplary embodiment, for the knowledge text “there is an x that is both A and B”, the computing device 100 may generate the logical formula “∃x[A(x)∧B(x)]” based on Table 1. The symbol ∀ represents a universal quantifier. The symbol ∃ represents an existential quantifier.

In another exemplary embodiment, for the knowledge text “a prime number is a natural number whose divisors are only 1 and itself”, the computing device 100 may also generate the logical formula prime(x)≡∀a·natural(x)∧(x≠1)∧(multiple(x,a)→(x=a)∨(a=1)). In addition to the foregoing logical constituent element, the computing device 100 according to the present disclosure may include various logical constituent elements for expressing the knowledge text for the concept word or the relationship information between the concept words as the logical formula.

The computing device 100 according to the present disclosure may match the knowledge text and the logical formula based on the table in which matching information for the text and the logical formula is recorded. The table may also be stored in the memory 130 or a database or separately stored in an external server. When the table is stored in the external server, the computing device 100 may receive the logical formula corresponding to the knowledge text or the relationship information of the concept words through the network unit 150. As described above, the computing device 100 according to the present disclosure may normalize the ambiguous expression of the natural language by expressing the knowledge text for each concept word included in the input document as the logical formula. That is, even in case of a sentence with an ambiguous meaning, the sentence primarily corresponds to the sentence with the logical formula with the single meaning, thereby achieving an effect of preventing a problem in the calculation process incurable due to the ambiguousness of the natural language.

The computing device 100 according to the present disclosure may generate an ontology language based on the logical formula. The ontology is a data model expressing a knowledge data structure of a specific field, and may formally express a concept and the relationship between the concepts. The constituent elements of the ontology may include a class, an instance, a relationship, an attribute, and the like. The attribute may mean a specific value of a class or an instance in order to represent a specific feature of the class or the instance. The relationship means relationships between the classes and the instances. The ontology language according to the present disclosure may include RDF, OWL, SWRL, and the like. The computing device 100 may express the concept words themselves and the relationship describing the association between the concept words in a standardized form by converting the logical formula to the ontology language. The ontology language according to the present disclosure may be generated based on the programming language disclosed by the W3C International Web Standards Organization.

In the several exemplary embodiments of the present disclosure, an intersection-related expression included in the logical formula may be expressed based on the function “ObjectIntersectionOf( )”. For example, the function “ObjectIntersectionOf(xsd:nonNegativeInteger xsd:nonPositiveInteger)” is the function for identifying data having an attribute of a non-negative integer and a non-positive integer. xsd is an abbreviation of “Xml Schema Datatype” and is a prefix for indicating a data type defined in the Xml language that is a well-known programming language. As a result, the function may select data having a value of “0” as an integer that is neither a negative integer nor a positive integer.

In the several exemplary embodiments of the present disclosure, the union-related expression included in the logical formula may be expressed based on a function ““ObjectUnionOf( )”. For example, a function “ObjectUnionOf(xsd:string xsd:integer)” may identify data of all string types and data of all integer types.

In the several exemplary embodiments of the present disclosure, a negation expression included in the logical formula may be expressed based on a function “ObjectComplementOf( )”. For example, the function “ObjectComplementOf(xsd:positiveInteger)” may identify non-positive integer data.

The computing device 100 in the exemplary embodiment of the present disclosure may express the logical formula prime(x)≡∀a·natural(x)∧(x≠1)∧(multiple(x,a)→(x=a)∨(a=1)) with the ontology language as represented below.
“EquivalentClasses(:primeNumber
ObjectIntersectionOf(:naturalNumber
ObjectComplementOf(DataHasValue(:hasVal “1”\hat{ }\hat{ }xsd:positiveInteger))
ObjectAllValuesFrom(isNumMultipleOf
ObjectUnionOf(DataHasValue(:hasVal “1”\hat{ }\hat{ }xsd:positiveInteger)
ObjectHasSelf(:isEqualTo)))))” Some examples for the ontology language expression for the constituent elements of the logical formula are merely examples, and the present disclosure includes the functions for expressing the logical formula in the ontology language without limitation. The types of specific functions for expressing the logical formula in the ontology language are more specifically discussed in the web document “https://www.w3.org/TR/owl-semantics/” (publication date: Feb. 10, 2004) for describing the OWL grammar, the entirety of which is incorporated in the present application as a reference.

The computing device 100 according to the present disclosure may generate knowledge graph data based on the generated ontology language. The knowledge graph data may be formed of a data structure in the form of a graph including nodes or edges. The knowledge graph data may include two or more concept word nodes expressing concept words, and at least one concept word relationship edge expressing the relationship between the concept words. The knowledge graph data including the concept word node or the concept word relationship edge according to the present disclosure may be generated by the computing device 100, and the concept word node may be generated based on the concept word expression included in the ontology language, and the concept word relationship edge may be generated based on the relationship expression between the concept words included in the ontology language.

In a first exemplary embodiment of the present disclosure, when there is the ontology language expressed like “a first relation function (a first factor, a second factor)”, the computing device 100 may generate nodes including information about the first factor and the second factor and an edge including information about the first relation function. Further, in this case, the edge including the information about the first relation function may be a concept word relationship edge connecting the node for the first factor and the node for the second factor. The first factor or the second factor may be a result value of a specific relation function again, and in this case, the node part for the corresponding factor may be substituted with the tree structure that is a set of the nodes.

In a second exemplary embodiment of the present disclosure, when there is the ontology language expressed like “a second relation function (a third factor, a fourth factor)”, the computing device 100 may generate a concept word node corresponding to each of the third factor, the fourth factor, and a second relation function calculation result. The concept word node corresponding to the second relation function calculation result may include information on eth calculation result of the second relation function based on the third factor and the fourth factor. That is, in the second exemplary embodiment, the second relation function may be the relation function for deriving a new value through the calculation based on the third factor and the fourth factor. As a result, the computing device 100 may generate a concept word relationship edge connecting the node for the third factor and the second relation function calculation result and a concept word relationship edge connecting the node for the fourth factor and the second relation function calculation result. The concept word relationship edges of the second exemplary embodiment may include information about the second relation function. The third factor or the fourth factor may be a result value of a specific relation function again, and in this case, the node part for the corresponding factor may be substituted with the tree structure that is a set of the nodes.

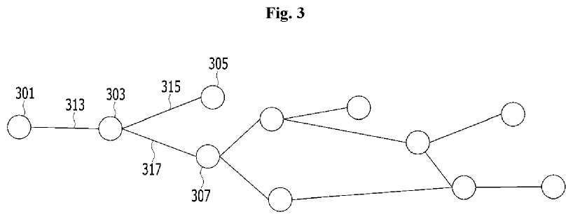

Hereinafter, the method of generating the knowledge graph data based on the ontology language will be described in detail with reference to FIG. 3. FIG. 3 a diagram illustrating an example of the knowledge graph data generated according to the exemplary embodiment of the present disclosure. FIG. 3 is a visualization of an example of a graph that may be expressed when knowledge graph data is generated based on the ontology language that may be expressed as “R_1(C_1, R_2(C_2, R_3))”. R_1, R_2, R_3 represents a relationship expression included in the ontology language. C_1, C_2 represents a concept word expression included in the ontology language. Referring to FIG. 3, a node 301 corresponding to concept word C_1 and the topmost node 303 of the knowledge graph obtained as a calculation result for R_2(C_2, R_3) may be connected through an edge 313 corresponding to the R_1 relationship expression. In the present example, the R_1 relationship expression may be the same type as that of the relation function described in the first exemplary embodiment. Continuously, the knowledge graph obtained as a calculation result for R_2(C_2, R_3) may form a new tree. The topmost node 303 of the knowledge graph obtained as the calculation result for R_2(C_2, R_3) and the node 305 corresponding to concept word C_2 may be connected through an edge 315 corresponding to the R_2 relationship expression. In the present example, the R_2 relationship may be the same type as that of the relation function described in the second exemplary embodiment. Reference numeral 307 may represent the topmost node of the knowledge graph obtained as the calculation result for R_3. The topmost node 307 of the knowledge graph obtained as the calculation result for R_3 and the topmost node 303 of the knowledge graph obtained as the calculation result for R_2(C_2, R_3) may be connected through an edge 317 corresponding to the R_2 relationship expression. The foregoing example is only an exemplary embodiment for describing the method of generating the knowledge graph data based on the ontology language consisting of the plurality of concept words and the relation function between the various concept words, and does not limit the present disclosure.

As described above, the computing device 100 of the present disclosure may express the relationship information between two or more concept words included in the input document or the knowledge text for each concept word included in the concept word list as the graph data. This has an effect of extracting information from the text, structuralizing the information, and visually transmitting the structuralized information to the user. Accordingly, when the knowledge graph data according to the present disclosure is used, it is possible to analyze the learning level of the user in the concept unit of the corresponding field, and provide a user customized learning method as a result. Further, it is possible to explain a recommendation process for a next learning concept in a transparent and interpretable manner through the analysis of the correlation between the knowledge concepts. Further, the present disclosure builds data in the graph structure by extracting meaningful information from the text, so that there is an advantage in speeding up data retrieval and query inference speed.

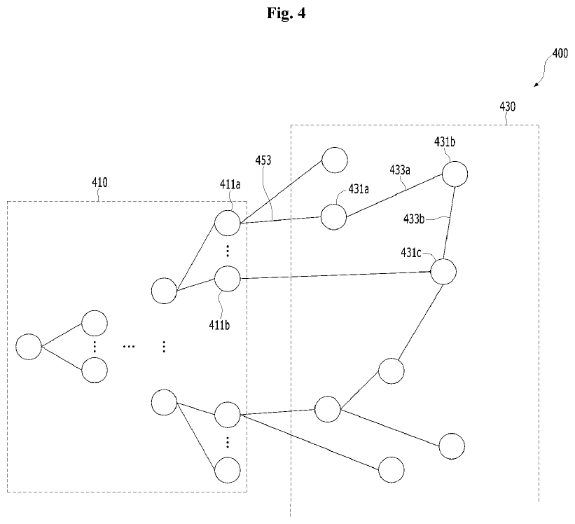

The knowledge graph data according to the present disclosure may further include at least one learning unit node expressing a learning unit and at least one concept word-learning unit edge expressing the relationship between the concept word and the learning unit. Hereinafter, the knowledge graph data that further includes the learning unit node and the concept word-learning unit edge will be described with reference to FIG. 4.

FIG. 4 is the diagram illustrating an example of knowledge graph data including a concept word node expressing a concept word and a learning unit node expressing a learning unit according to the exemplary embodiment of the present disclosure. The knowledge graph data of FIG. 4 may also be expressed to a user through a user interface. A knowledge graph data 400 may be divided into a first partial graph 410 and a second partial graph 430 based on the type of node included in each part graph. The first partial graph 410 may include one or more learning unit nodes representing the learning unit information described with reference to FIG. 2. The second partial graph 430 may include one or more concept word nodes expressing the concept words that have been described with reference to FIG. 3.

A minimum learning unit node included in the first partial graph 410 may be connected with one or more concept word nodes corresponding to the learning units, respectively. For example, a minimum learning unit node 411a corresponding to “middle school 1st grade, 1st semester, 1st lesson unit” may be connected to a concept word node 431a for “factorization”. Further, a minimum learning unit node 411b corresponding to “middle school 1st grade, 1st semester, 2nd lesson unit” may be connected to a concept word node 431c for “rational number”. Some concept word nodes 431b included in the second partial graph 430 may not be connected with the minimum learning unit node, but may also be connected only with other concept word nodes 431a and 431c.

The knowledge graph data 400 may include at least one concept word-learning unit edge 453 connecting the node included in the first partial graph 410 and the node included in the second partial graph 430. In several exemplary embodiments of the present disclosure, the concept word-learning unit edge 453 may be generated based on the learning unit information which the computing device 100 obtains for the concept word included in the input document. The second partial graph 430 may include concept word relationship edges 433a and 433b expressing the relationship between the concept words. The concept word relationship edges 433a and 433b may include relationship information between the concept words including the inclusion relationship, the precedence relationship, and the association relationship between two concept words. In several exemplary embodiments of the present disclosure, the concept word relationship edges 433a and 433b may be generated at least partially based on the relationship information between the two concept words included in the concept word list calculated by the computing device 100 or the knowledge text for each concept word included in the concept word list. As described above, in the present disclosure, the concept word-learning unit edges and the concept word relationship edges may be obtained based on the result of the different time points or the different operations by the computing device 100, and the computing device 100 may separate and store the concept word relationship edge and the concept word-learning unit edge.

The first partial graph 410 included in the knowledge graph data 400 includes learning unit information. The learning unit information may be obtained in the parsing process for the input document as described above. The nodes included in the first partial graph 410 may be topologically sorted. In the present disclosure, the learning unit information included in the first partial graph 410 is the expression of the learning order in a graph, and topological sort is possible so that a cycle does not occur. Further, the first partial graph 410 may also be expressed in a tree structure. Accordingly, when the computing device 100 selects one node included in the first partial graph 410, the 10 may identify a subordinate node and/or child nodes.

The second partial graph 430 included in the knowledge graph data 400 includes one or more concept word nodes and a concept word relationship edge representing a relationship between the concept words. The nodes and the edges included in the second partial graph 430 represent the relationship between the plurality of concept words.

According to the present disclosure, when the foregoing knowledge graph data 400 is used, the user may select a node or a vertex peak for entry into the knowledge graph based on the first partial graph 410. For example, when the user selects a minimum learning unit node 411a corresponding to “middle school 1st grade, 1st semester, 1st lesson unit” of the first partial graph 410, the computing device 100 may identify concept word nodes connected to the minimum learning unit node 411a and the concept word-learning unit edge and determine the identified concept word nodes as starting nodes in the second partial graph 430. For another example, even when the user selects a predetermined learning unit node included in the first partial graph 410, the computing device 100 may identify concept word nodes connected to one or more minimum learning unit nodes included in the corresponding learning unit node and then determine one or more starting nodes in the second partial graph 430. When the knowledge graph data is configured as illustrated in FIG. 4 of the present disclosure, the user is capable of conveniently selecting the learning unit desired to be learned and the computing device 100 may provide the concept word that is the basis of the selected learning unit.

The computing device 100 according to the present disclosure may also configure the user interface by a method of providing only the second partial graph 430 illustrated in FIG. 4 as the knowledge graph data when visually providing the knowledge graph data to the user, and visually expressing the nodes to be different when the learning units related to the respective concept word nodes are different from each other.

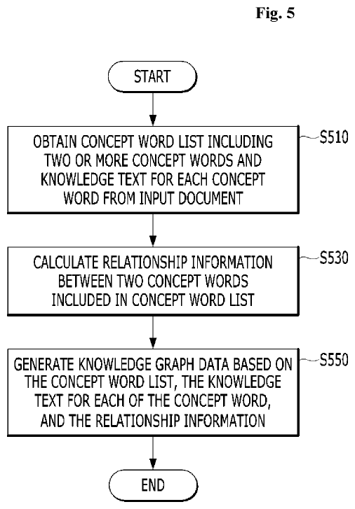

FIG. 5 is a flowchart illustrating a method of generating knowledge graph data according to an exemplary embodiment of the present disclosure. The computing device 100 may obtain a concept word list including two or more concept words and a knowledge text for each concept word from the input document (S510). The computing device 100 may perform a morpheme analysis on the text included in the input document and extract a concept word as a result. The computing device 100 may extract text tokens corresponding to nouns or noun phrases among the text tokens included in the input document as the concept words. The computing device 100 may calculate relationship information between two concept words included in the concept word list (S530). The relationship information between the two concept words may include an association relationship, an inclusion relationship, or a precedence relationship. The relationship information may be obtained as a result of performing the analysis on a sentence including each concept word. The association relationship may be calculated based on a distance between the two concept words or a co-appearance frequency of the two concept words in the input document. The computing device 100 may generate knowledge graph data based on the concept word list, the knowledge text for each concept word, and the relationship information (S550). The computing device 100 may generate a logical formula based on the knowledge text for the concept word or the relationship information between the concept words. The computing device 100 may generate an ontology language based on the generated logical formula. The computing device 100 may generate knowledge graph data based on the generated ontology language.

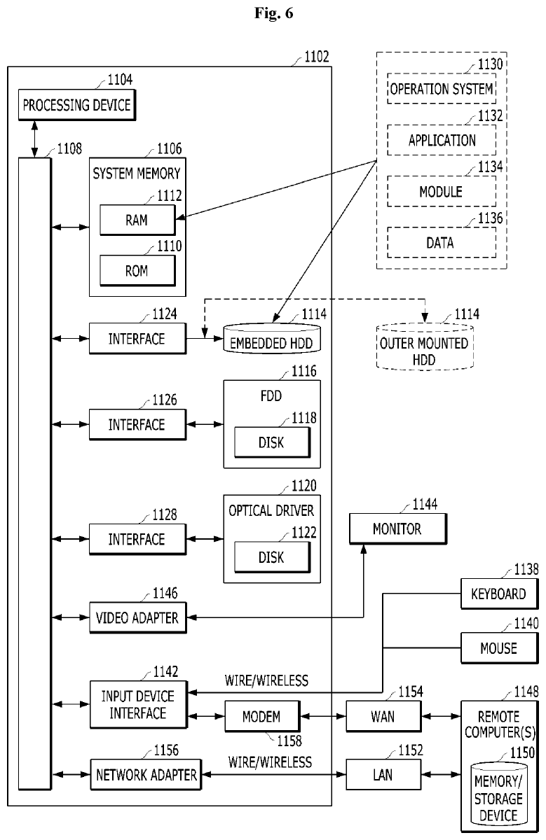

FIG. 6 is a simple and general schematic diagram illustrating an example of a computing environment in which the exemplary embodiments of the present disclosure are implementable. The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a Random Access Memory (RAM), a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable storage media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1552 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A method of generating knowledge graph data performed by a computing device including at least one processor, the method comprising:
obtaining a concept word list including two or more concept words and a knowledge text for each concept word from an input document;
calculating relationship information between two concept words included in the concept word list; and
generating knowledge graph data based on the concept word list, the knowledge text for each of the concept words and the relationship information.

2. The method of claim 1, wherein the obtaining of the concept word list including the two or more concept words and the knowledge text for each concept word from the input document includes:
obtaining learning unit information for at least one text included in the input document; and
obtaining the concept word list including two or more concept words and the knowledge text for each concept word based on the learning unit information.

3. The method of claim 2, wherein the learning unit information includes two or more learning unit elements having a parent-child relationship.

4. The method of claim 1, wherein the relationship information between the two concept words included in the concept word list includes an association relationship representing whether the concept words are associated or the degree of association, and
the association relationship is calculated based on a distance between the two concept words or a co-appearance frequency of the two concept words in the input document.

5. The method of claim 1, wherein the relationship information between the two concept words included in the concept word list includes an inclusion relationship representing a superordinate-subordinate relationship between the concept words, and
the inclusion relationship is determined based on a morpheme analysis result of a knowledge text for at least one of a first concept word and a second concept word which have an association relationship.

6. The method of claim 1, wherein the relationship information between the two concept words included in the concept word list includes a precedence relationship representing a precedence relationship between the concept words, and
the precedence relationship is determined based on a morpheme analysis result of a knowledge text for at least one of a first concept word and a second concept word which have an association relationship.

7. The method of claim 6, wherein the precedence relationship is determined based on a comparison result of learning unit information for each of the first concept word and the second concept word which have the association relationship.

8. The method of claim 1, wherein the generating of the knowledge graph data based on the concept word list, the knowledge text for each of the concept words, and the relationship information includes:
generating a logical formula based on the knowledge text or the relationship information for the concept word;
generating an ontology language based on the generated logical formula; and
generating knowledge graph data based on the generated ontology language.

9. The method of claim 8, wherein the knowledge graph data includes a concept word node or a concept word relationship edge, and
the concept word node is generated based on a concept word expression included in the ontology language, and
the concept word relationship edge is generated based on a relationship expression included in the ontology language.

10. The method of claim 1, wherein the knowledge graph data includes:
two or more concept word nodes expressing the concept words; and
at least one concept word relationship edge expressing the relationship between the concept words.

11. The method of claim 10, wherein the knowledge graph data further includes:
at least one learning unit node expressing a learning unit; and
at least one concept word-learning unit edge expressing a relationship between the concept word and the learning unit.

12. A computer program stored in a computer readable storage medium, wherein when the computer program is executed by one or more processors, the computer program performs following operations for generating knowledge graph data, the operations comprising:
obtaining a concept word list including two or more concept words and a knowledge text for each concept word from an input document;
calculating relationship information between two concept words included in the concept word list; and
generating knowledge graph data based on the concept word list, the knowledge text for each of the concept words, and the relationship information.

13. An apparatus for generating knowledge graph data, the apparatus comprising:
one or more processors;
a memory; and
a network unit,
wherein the one or more processors obtain a concept word list including two or more concept words and a knowledge text for each concept word from an input document,
calculate relationship information between two concept words included in the concept word list, and
generate knowledge graph data based on the concept word list, the knowledge text for each of the concept words, and the relationship information.
